(19) United States
(12) Patent Application Publication
(10) Pub. No.: US 2021/0364031 A1
(43) Pub. Date: Nov. 25, 2021

(54) VIBRATION RESISTANT FASTENER ASSEMBLY

(71) Applicant: Aktiebolaget SKF, Göteborg (SE)

(72) Inventors: Amol Bashetti, Pune (IN); Gopal Kamble, Pune (IN); Raju Pal, Pune (IN); Johnson Rego, Pune (IN)

(21) Appl. No.: 17/242,479

(22) Filed: Apr. 28, 2021

(30) Foreign Application Priority Data
May 19, 2020 (IN) 202041021007

(51) Int. Cl. F16B 39/26

(52) U.S. Cl. CPC F16B 39/26

(57) ABSTRACT

Disclosed is a fastener assembly to avoid accidental loosening due to vibrations. The fastener assembly includes a circular profiled locking washer and a lock nut. The locking washer is detachably attachable to an arm. The locking washer provides a plurality of leaf-shaped grooves on a first surface, and a central axial aperture for receiving a threaded shaft. The lock nut further provides a plurality of spring loaded balls on a surface facing the first surface of the locking washer. During operation, the lock nut is tightened on the threaded shaft by rotating in clockwise direction, and cessation of rotation, latches the plurality of spring loaded balls with the plurality of leaf-shaped grooves to lock the lock nut, and hence to withstand counter-rotative torque on the lock nut caused by vibrations.

### CROSS-REFERENCE TO RELATED APPLICATIONS

This application claims priority to India Patent Application no. 202041021007, filed May 19, 2020, the contents of which is fully incorporated herein by reference.

### FIELD OF THE INVENTION

The present disclosure generally relates to fasteners and fastener assemblies, and more particularly relates to a vibration resistant fastener assembly.

### BACKGROUND OF THE INVENTION

During cultivation, primary tilling and secondary tilling of the land is done to make a good seedbed for the crops. Typically for secondary tillage, a hub mounted on a tractor are commonly used as implements. A hub frame typically comprises an attachment link, a beam, at least one furrow wheel, and a plurality of disc blades. The disc blades are attached to a hub assembly secured on the beam through a tillage machine arm wherein the hub is mounted on the tillage machine arm with the help of a fastener or a nut. Due to harsh environment like vibrations, high tilting forces, shock loads and stone impacts during secondary tillage, the fasteners or nuts loosen. The loosening of the nut gives rise to loss of bearing preload and can lead to unfastening of the nut, further resulting in dislocation of the hub or damage of the hub assembly. In some instances, loosening of the nut can lead to reduced life of the hub.

A nut is a type of fastener with a threaded hole and is used in conjunction with bolts to fasten various parts of a machinery. There are various types of nuts available and the principle of fastening differs with each nut. Most of the nuts work on the principle of friction between the threads, while some nuts work on the principle of tension. Some examples of nuts are standard nuts with washers, nuts with nylon patch, distorted thread locknut, split nut, castle nut etc.

One existing mechanism to secure bolted joints is to use a Nyloc nut. A Nyloc nut is a locknut with a nylon collar insert. The nylon insert locks the nut by friction against the screw. The Nyloc nut is inefficient when it comes to sustaining vibrations. Moreover, the Nyloc nut unlocks when subjected to higher reverse torques and hence is less reliable for high torque applications like secondary tillage. Another mechanism to secure bolted joints is to use a Wedge-lock nut that secures bolted joints with tension instead of friction. Wedge-lock nuts offer higher reliability and can secure bolted joints even when subjected to extreme vibration or dynamic loads. However, Wedge-lock nuts are costly and hence may not be suitable for secondary tillage applications.

### BRIEF SUMMARY OF THE INVENTION

This summary is provided to introduce a selection of concepts in a simple manner that is further described in the detailed description of the disclosure. This summary is not intended to identify key or essential inventive concepts of the subject matter nor is it intended for determining the scope of the disclosure.

The present disclosure discloses a vibration resistant fastener assembly to withstand counter-rotative torque caused by the vibrations and hence to avoid accidental loosening of the fastener assembly. The vibration resistant fastener assembly comprises a circular profiled locking washer having a central axial aperture for receiving a threaded shaft and a lock nut configured for threadedly engaging with the threaded shaft. The circular profiled locking washer comprises a plurality of leaf-shaped grooves on a first surface, and a portion of the circular profiled locking washer is truncated for engaging with a truncated circular aperture of an arm. On the other hand, the lock nut comprises a plurality of spring loaded balls on a surface facing the first surface of the circular profiled locking washer. When the lock nut is fitted on to the threaded shaft and tightened by rotating in clockwise direction, the plurality of spring loaded balls rides on the plurality of leaf-shaped grooves on the circular profiled locking washer, and on cessation of rotation, latches the plurality of spring loaded balls with the plurality of leaf-shaped grooves on the circular profiled locking washer for locking the lock nut and the circular profiled locking washer, and hence withstands counter-rotative torque on the lock nut caused by the vibrations.

To further clarify advantages and features of the present disclosure, a more particular description of the disclosure will be rendered by reference to specific embodiments thereof, which is illustrated in the appended figures. It is to be appreciated that these figures depict only typical embodiments of the disclosure and are therefore not to be considered limiting of its scope. The disclosure will be described and explained with additional specificity and detail with the accompanying figures.

### BRIEF DESCRIPTION OF THE FIGURES

The disclosure will be described and explained with additional specificity and detail with the accompanying figures in which:

FIG. 1 illustrates a vibration resistant fastener assembly in accordance with an embodiment of the present disclosure;

FIG. 2A illustrates the circular profiled locking washer 105 in accordance with an embodiment of the present disclosure;

FIG. 2B shows a truncated portion 215 of the circular profiled locking washer 105 in accordance with an embodiment of the present disclosure;

FIG. 3 illustrates an exemplary lock nut 110 having three spring loaded balls in accordance with an embodiment of the present disclosure;

FIG. 4A illustrates an exemplary lock nut in accordance with an embodiment of the present disclosure;

FIG. 4B illustrates an exemplary lock nut in accordance with an embodiment of the present disclosure;

FIG. 5 illustrates an exploded view of the vibration resistant fastener assembly 100 in accordance with an embodiment of the present disclosure; and

FIG. 6 illustrates an exploded view of the vibration resistant fastener assembly 100 in accordance with a further embodiment of the present disclosure.

Further, persons skilled in the art to which this disclosure belongs will appreciate that elements in the figures are illustrated for simplicity and may not have been necessarily drawn to scale. Furthermore, in terms of the construction of the joining ring and one or more components of the bearing assembly may have been represented in the figures by conventional symbols, and the figures may show only those specific details that are pertinent to understanding the embodiments of the present disclosure so as not to obscure the figures with details that will be readily apparent to those of ordinary skill in the art having benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications to the disclosure, and such further applications of the principles of the disclosure as described herein being contemplated as would normally occur to one skilled in the art to which the disclosure relates are deemed to be a part of this disclosure.

It will be understood by those skilled in the art that the foregoing general description and the following detailed description are exemplary and explanatory of the disclosure and are not intended to be restrictive thereof.

In the present disclosure, relational terms such as first and second, and the like, may be used to distinguish one entity from the other, without necessarily implying any actual relationship or order between such entities.

The terms “comprises”, “comprising”, or any other variations thereof, are intended to cover a non-exclusive inclusion, such that a process or method that comprises a list of steps does not include only those steps but may include other steps not expressly listed or inherent to such a process or a method. Similarly, one or more elements or structures or components preceded by “comprises . . . a” does not, without more constraints, preclude the existence of other elements, other structures, other components, additional devices, additional elements, additional structures, or additional components. Appearances of the phrase “in an embodiment”, “in another embodiment” and similar language throughout this specification may, but do not necessarily, all refer to the same embodiment.

Unless otherwise defined, all technical and scientific terms used herein have the same meaning as commonly understood by one of ordinary skill in the art to which this disclosure belongs. The components, methods, and examples provided herein are illustrative only and not intended to be limiting.

The present disclosure relates to a vibration resistant fastener assembly. The vibration resistant fastener assembly comprises a circular profiled locking washer, and a lock nut, wherein the circular profiled locking washer is detachably attachable to an arm. The circular profiled locking washer comprises a plurality of leaf-shaped grooves on a first surface, and a central axial aperture for receiving a threaded shaft. Further, a portion of the circular profiled locking washer is truncated for engaging with a truncated circular aperture of the arm. On the other hand, the lock nut comprises a plurality of spring loaded balls on a surface facing the first surface of the circular profiled locking washer. During assembly, the circular profiled locking washer is inserted in the truncated circular aperture of the arm and the threaded shaft is inserted into the central axial aperture of the circular profiled locking washer. Further, the lock nut is tightened on the threaded shaft by rotating in clockwise direction, and upon cessation of the rotation, the plurality of spring loaded balls latches with the plurality of leaf-shaped grooves on the first surface of the circular profiled locking washer for locking the lock nut and the circular profiled locking washer and hence to withstand counter-rotative torque on the lock nut caused by the vibrations and thereby providing vibration resistance to the fastener assembly.

Embodiments of the present disclosure will be described below in detail with reference to the accompanying figures.

Typically, in agricultural tillage application for soil preparation, a hub is mounted on a machine arm with the help of fasteners. The vibration resistant fastener assembly is used for mounting the hub on the machine arm. It avoids dislocation of the hub and preload loss affecting the system performance, and increases the life of the hub, as disclosed in the present disclosure. It is to be noted that the vibration resistant fastener assembly of the present disclosure may be used in automotive, engineering, and other industrial applications.

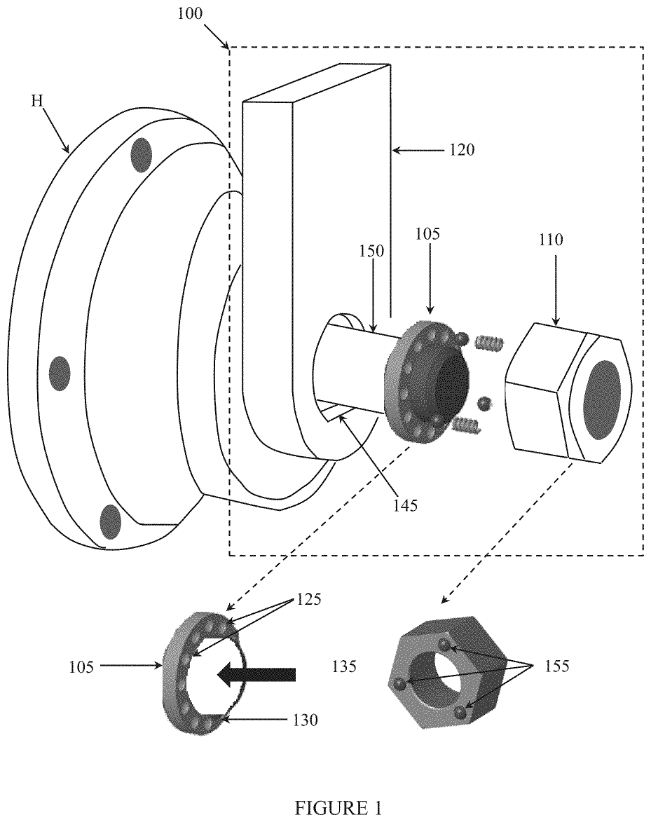

FIG. 1 illustrates a vibration resistant fastener assembly in accordance with an embodiment of the present disclosure. As illustrated, the vibration resistant fastener assembly 100 (hereinafter referred as fastener assembly 100) is used for mounting a hub “H” on a machine arm 120, wherein the hub is used in secondary tillage application. In one embodiment of the present disclosure, the fastener assembly 100 comprises a circular profiled locking washer 105 and a lock nut 110, wherein the circular profiled locking washer 105 is detachably attachable to the arm 120 for fastening the hub “H”.

The circular profiled locking washer 105 is made of any of the following materials like steel, non-ferrous metal, or alloys. In one embodiment of the present disclosure, the circular profiled locking washer 105 comprises a plurality of leaf-shaped grooves 125 on a first surface 130, and a central axial aperture 135 for receiving a threaded shaft 150. As shown in FIG. 1, the plurality of leaf-shaped grooves 125 on the circular profiled locking washer 105 is semi-circular at one end and the other end is tapering gradually for providing low resistance during tightening of the lock nut 110. It is to be noted that the semi-circular portion of the leaf-shaped grooves 125 is designed so as to receive the spring loaded ball when the lock nut 110 is in locked position. In an embodiment of the present disclosure, a circular portion of the circular profiled locking washer 105 is truncated for engaging with a truncated circular aperture 145 of the arm 120. That is, the arm 120 comprising the truncated circular aperture 145 receives the circular profiled locking washer 105, and the truncated portion of the circular aperture 145 of the arm 120 and the truncated portion of the circular profiled locking washer 105 are aligned such that it constraints rotational degree of freedom. It is to be noted that the inner diameter of the circular aperture 145 of the arm 120 is same as the outer diameter of the circular portion of the circular profiled locking washer 105 so as to firmly engage the circular profiled locking washer 105 inside the circular aperture 145 of the arm 120.

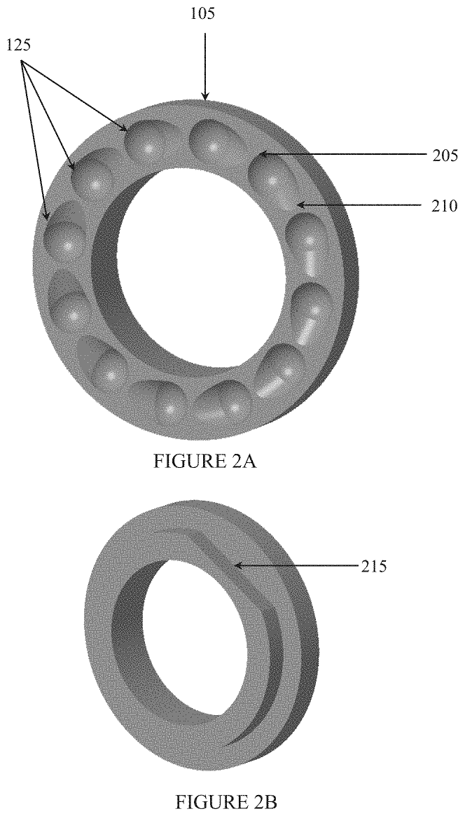

FIG. 2A illustrates the circular profiled locking washer 105 in accordance with an embodiment of the present disclosure. As shown, the circular profiled locking washer 105 comprises the plurality of leaf-shaped grooves 125 on one of the surfaces. One end 205 of each of the leaf-shaped grooves is semi-circular in shape and tapered towards the second end 210.

FIG. 2B shows a truncated portion 215 of the circular profiled locking washer 105 in accordance with an embodiment of the present disclosure. The truncated portion 215 engages with the truncated portion of the circular aperture 145 of the arm 120.

The lock nut 110 is made of materials such as steel or steel alloy, and the like. The lock nut 110 comprises internal threads (female threads) which engage with male threads of an associated threaded shaft 150, on which the hub “H” is mounted. In one embodiment of the present disclosure, the lock nut 110 comprises a plurality of spring loaded balls 155 on a surface, the surface facing the first surface of the circular profiled locking washer 105 when the lock nut 110 is assembled. The plurality of spring loaded balls 155 latches with the plurality of leaf-shaped grooves 125 of the circular profiled locking washer 105 to lock the lock nut 110 and the circular profiled locking washer 105 and hence to withstand counter-rotative torque on the lock nut 110 caused by the vibrations and hence to avoid accidental loosening of the lock nut 110.

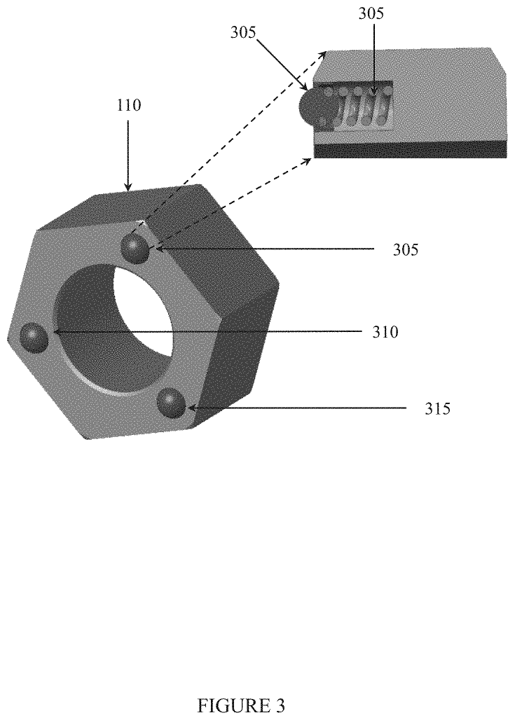

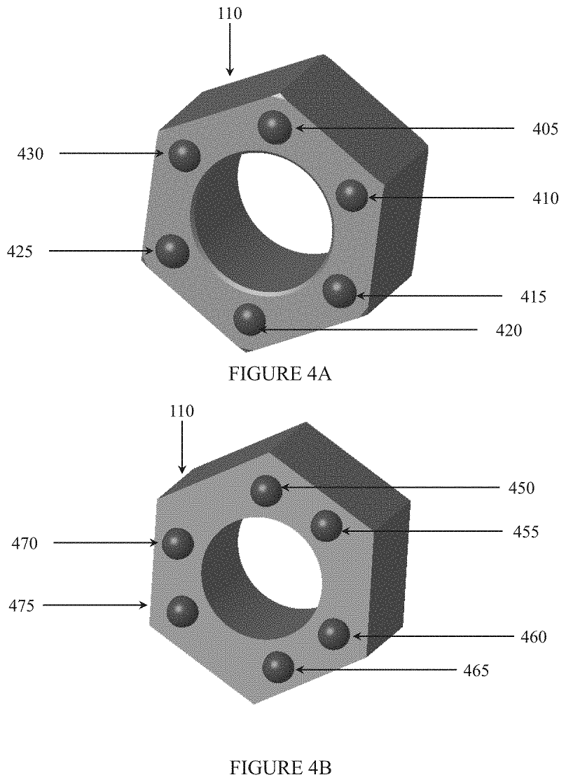

FIG. 3 illustrates an exemplary lock nut 110 having three spring loaded balls in accordance with an embodiment of the present disclosure. As shown, the three spring loaded balls 305, 310 and 315 are spaced at equidistant from one another, that is, the three spring loaded balls 305, 310 and 315 are spaced at 120 degrees apart. In another embodiment of the present disclosure, the lock nut 110 comprises six spring loaded balls 405 to 430 spaced at equidistant from one another, as shown in FIG. 4A. In one example, the spring loaded balls 405 to 430 may be spaced 60 degrees apart. In yet another embodiment of the present disclosure, the lock nut 110 comprises six spring loaded balls 450 to 475 with offset-spacing, as shown in FIG. 4B.

Referring to FIG. 3 now, each spring loaded ball (for example ball 305 as shown) is partially (preferable H portion) held inside the lock nut 110 by means of crimping and a compression spring 320 exerts an axial force on the ball 305. The spring action on the ball 305 by means of the spring 320 enables smooth riding of the ball 305 on the plurality of leaf-shaped grooves 125 during tightening of the lock nut 110, and the axial force on the ball 305 by means of the spring 320 locks the ball 305 in the semi-circular portion of the leaf-shaped groove on the circular profiled locking washer 105. Similarly, the plurality of spring loaded balls 155 (Referring back to FIG. 1) gets locked in the plurality of leaf-shaped grooves 125 when the lock nut 110 is tightened and provides resistance to the vibration.

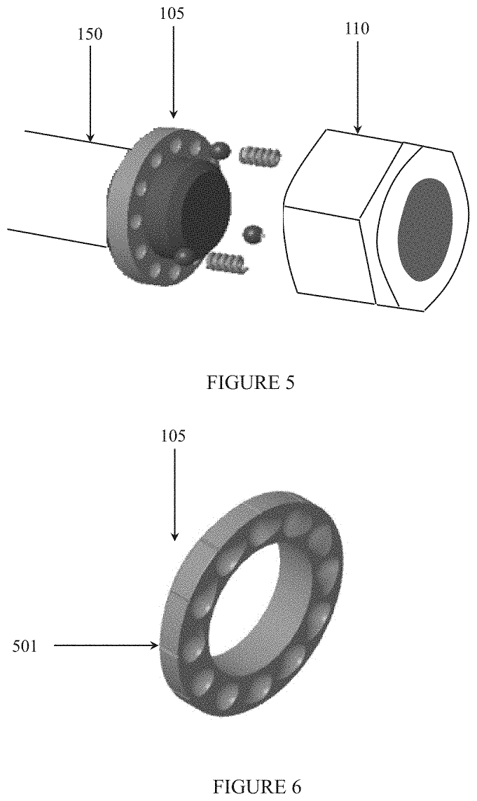

FIG. 5 illustrates an exploded view of the vibration resistant fastener assembly 100 in accordance with an embodiment of the present disclosure. Referring to FIG. 1 in conjunction with FIG. 5, the following steps enumerate the various actions during assembly. The hub “H” having the threaded shaft 150 and the arm 120 having the truncated circular aperture 145 is shown in FIG. 1. The circular profiled locking washer 105 is inserted in the truncated circular aperture 145 of the arm 120 through the threaded shaft 150. The truncated portions of the circular aperture 145 and the circular profiled locking washer 105 restricts the rotational degree of freedom. Then, the lock nut 110 having the plurality of spring loaded balls 155 is fitted on to the threaded shaft 150 and tightened by rotating in clockwise direction. During rotation, the plurality of spring loaded balls 155 rides on the plurality of leaf-shaped grooves 125 on the circular profiled locking washer 105, and upon cessation of rotation, the plurality of spring loaded balls 155 latches with the plurality of leaf-shaped grooves 125. The latching of the plurality of spring loaded balls 155 with the leaf-shaped grooves 125 locks the lock nut 110 and the circular profiled locking washer 105 (the fastener assembly 100) to withstand counter-rotative torque on the lock nut 110 caused by the vibrations and further avoids accidental loosening of the lock nut 110. The gradual tapering profile of the leaf-shaped grooves 125 provides low resistance during tightening of the lock nut 110 and the semi-circular profile of the leaf-shaped groves 125 resists the counterclockwise rotation of the lock nut 110 during vibrations (counter-rotative torque on the lock nut 110 caused by the vibrations). However, high torque may be applied in counterclockwise direction using a wrench for loosening the lock nut 110 and hence for disassembling fastener assembly 100 for changing the hub, during maintenance, etc.

FIG. 6 illustrates an exemplary circular profiled locking washer 105 in accordance with a further embodiment of the present disclosure. As shown, the circular profiled locking washer 105 comprises a number of equally circumferentially spaced axial grooves 501. These grooves 501 ensure balls 155 on the lock nut 110 fit into the of leaf-shaped grooves 125 from the beginning to avoid any movement/slipping of ball 155 from leaf-shaped grooves 125 which can lead to transverse load loss.

As discussed in the foregoing sections, the vibration resistant fastener assembly 100 with said locking mechanism by means of the circular profiled locking washer 105 having the plurality of leaf-shaped grooves 125, and lock nut 110 having the plurality of spring loaded balls 155, is reliable for high torque applications like secondary tillage as the said locking eliminates unintentional loosening of the lock nut 110, loss of lock nut 110, dislocation of the hub unit, and preload loss affecting the assembly unit or system performance. The leaf-shaped grooves 125 on the circular profiled locking washer 105 provides low resistance during clockwise rotation of the lock nut 110 and high resistance during anti-clockwise rotation (due to vibrations) of the lock nut 110. Furthermore, it is to be noted that the vibration resistant fastener assembly 100 disclosed in the present disclosure may be used with conventional threaded shafts and hub assemblies.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

### LIST OF REFERENCE NUMERALS

Vibration resistant fastener assembly—100

Circular profiled locking washer—105

Lock nut—110

Arm—120

A plurality of leaf-shaped grooves—125

A first surface of the circular profiled locking washer (105)—130

Central axial aperture (of circular profiled locking washer 105)—135

Truncated circular aperture (of arm 120)—145

Threaded shaft—150

A plurality of spring loaded balls—155

We claim:

1. A vibration resistant fastener assembly comprising:
a circular profiled locking washer comprising a plurality of leaf-shaped grooves on a first surface, and a central axial aperture for receiving a threaded shaft, wherein the circular profiled locking washer is detachably attachable to an arm; and a lock nut configured for threadedly engaging with the threaded shaft, the lock nut comprising a plurality of spring loaded balls on a surface facing the first surface of the circular profiled locking washer wherein, rotation of the lock nut in clockwise direction tightens the lock nut on the threaded shaft and cessation of the rotation, latches the plurality of spring loaded balls with the plurality of leaf-shaped grooves on the first surface of the circular profiled locking washer.

2. The vibration resistant fastener assembly as claimed in claim 1, wherein the lock nut comprising the plurality of spring loaded balls is one of, a lock nut comprising three spring loaded balls with equidistant spacing between each ball, a lock nut comprising six spring loaded balls with equidistant spacing between each ball, and a locknut comprising six spring loaded balls with offset-spacing.

3. The vibration resistant fastener assembly as claimed in claim 1, wherein latching of the spring loaded balls with the leaf-shaped grooves on the first surface of the circular profiled locking washer resists counter-rotative torque caused by vibrations and unlocking of the lock nut during vibration.

4. The vibration resistant fastener assembly as claimed in claim 1, wherein profile of the leaf-shaped grooves on the circular profiled locking washer is semi-circular at one end and tapering gradually towards the second end.

5. The vibration resistant fastener assembly as claimed in claim 4, wherein gradual tapering profile of the leaf-shaped grooves provides low resistance during tightening of the lock nut and the semi-circular profile of the leaf-shaped grooves provides resistance to counter-rotative torque caused by vibrations and unlocking of the lock nut during vibration.

6. The vibration resistant fastener assembly as claimed in claim 1, wherein the arm comprises a truncated circular aperture for receiving and engaging the circular profiled locking washer.

7. The vibration resistant fastener assembly as claimed in claim 6, wherein a circular portion of the circular profiled locking washer is truncated for engaging with the truncated circular aperture of the arm.

8. The vibration resistant fastener assembly as claimed in claim 1, wherein the circular profiled locking washer is made of one of a steel, non-ferrous metal, or alloys.

9. The vibration resistant fastener assembly as claimed in claim 1, wherein the circular profiled locking washer is provided with a number of equally circumferentially spaced axial grooves.
